(19) United States
(12) Patent Application Publication
(10) Pub. No.: US 2001/0029970 A1
(43) Pub. Date: Oct. 18, 2001

(54) Washing and rinsing station for work pieces transferred on a pallet

(76) Inventor: Juhana Kantola, Tampere (FI)

Correspondence Address: LAW OFFICE OF LOUIS WOO, Suite 402, 1828 L. Street, N.W., Washington, DC, 20036, US

(21) Appl. No.: 09/804,395

(22) Filed: Mar. 13, 2001

(30) Foreign Application Priority Data
Apr. 13, 2000 (FI) 20000882

(51) Int. Cl. B08B 3/02

(52) U.S. Cl. 134/32; 134/80; 134/104.4

(57) ABSTRACT

A washing and rinsing station intended for treatment of work pieces fastened onto a pallet. The station comprises a pallet table which is arranged to receive and deliver the pallet and to lock it at its place, wherein the pallet table is connected to a rotation axle for turning the work piece by inclining it away from the change position and to the treatment position. At least one pallet table is further connected on said rotation axle in a manner that said pallet tables swivel around the rotation axle at the same time and in the same direction along a circular route, when one pallet table is turned from the change position to the treatment position for washing, cleaning and drainage, wherein another pallet table is arranged at the same time to turn from the treatment position to the change position for a pallet change.

### BACKGROUND OF THE INVENTION

1. Field of the Invention

The present invention relates to a washing and rinsing station of work pieces according to the preamble of the appended claim 1. The invention further relates to a method in the washing and rinsing station of work pieces according to the preamble of the appended claim 10.

2. Description of the Related Art

In automatic flexible manufacturing systems (FMS), various washing and rinsing stations are used for cleaning of manufactured work pieces. Various cutting fluids are used in the machining of work pieces, for example for cooling the work piece and the tool, and for flushing chips from the machined object. However, a part of the cutting fluids and chips end up in cavities of the work piece, soiling the piece itself, wherein the work piece is cleaned and loose contaminants are removed in a washing and rinsing station.

Patent publication U.S. Pat. No. 5,450,867 discloses a washing station utilizing a robot for transferring a vertical work piece on a pallet to a work table on which the pallet is fastened. By using the work table, the work piece is turned by tilting it to the horizontal direction and rotated around the horizontal axis for washing. The robot can be used for deburring in the same station.

### SUMMARY OF THE INVENTION

The purpose of the present invention is to present a washing and rinsing station having a higher capacity than solutions of prior art. The washing station according to the invention enables simultaneous treatment of several work pieces. This brings the advantage that a work piece can be fed into the station or removed from the station even while another piece is being treated. A particular advantage is that the processing of the work piece is combined to the washing station itself, wherein no turntables and transport apparatuses are needed before the separate washing station. The control and configuration of the apparatus are significantly simplified. Even the rotary movement is not always compulsory, because the work piece has a plurality of positions in any case.

The washing and rinsing station according to the invention is characterized in what will be presented in the characterizing part of the appended claim 1. The method in the washing and rinsing station according to the invention is characterized in what will be presented in the characterizing part of the appended claim 10.

An advantage provided by the invention is the increased capacity in the washing and rinsing station, particularly in automatic and semi-automatic systems in which stacker cranes attend to the transport of pallets. Moving an empty stacker crane at the station is not necessary, because the same crane can be used for bringing a new piece to the station and transporting the cleaned piece away. Movements of the washing station, particularly different positions of an inclined piece, are more versatile compared to prior art, wherein various and divergent chambers can be emptied more reliably.

### BRIEF DESCRIPTION OF THE DRAWINGS

In the following, the invention will be described in more detail with reference to the appended drawings, in which

FIG. 1 shows a side view and a partial cross-section of a washing and rinsing station according to a preferred embodiment of the invention, and

FIG. 2 shows a front view and a partial cross-section of a washing and rinsing station according to FIG. 1.

### DETAILED DESCRIPTION OF THE INVENTION

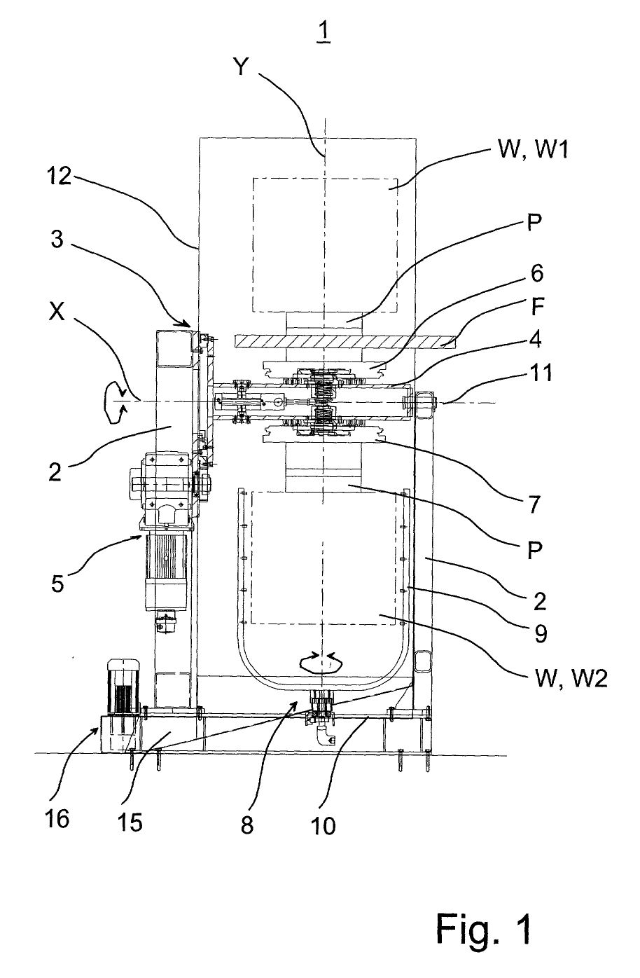

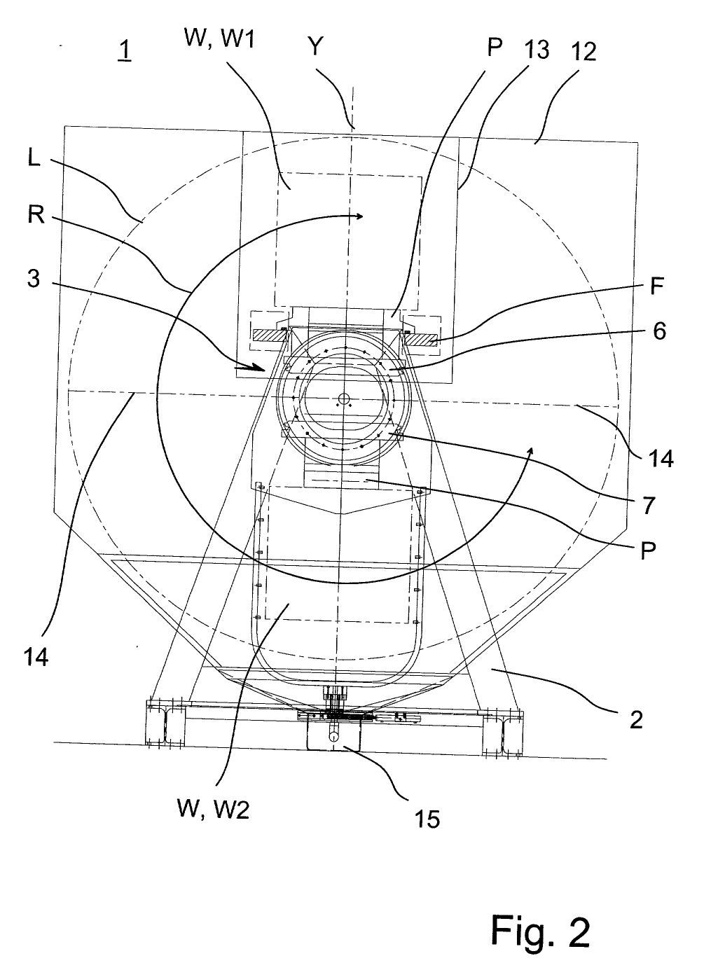

FIGS. 1 and 2 show a washing and rinsing station 1 according to a preferred embodiment of the invention, which in the following will be called merely a washing station. The washing station 1 comprises a horizontal rotation axle 4 coupled to a beam-like frame structure 2 with a joint 3. The axle 4 is arranged to rotate the work pieces W substantially clockwise and counter-clockwise around a substantially horizontal direction X. The frame 2 comprises a vertical triangular beam assembly standing on a floor A and having an axle 4 pivoted at the upper end thereof. In connection with the bearing 3 a rotation motor 5 is provided, comprising for example an electric motor and a gearing. The output of the gearing has a notched wheel adapting at a chain wheel of the axle 4 to transmit a rotary movement. At least two pallet tables 6 and 7 are fastened on the sides of the axle 4. Two tables are fastened preferably on the opposite sides of the axle 4, at a spacing of 180°; three tables preferably at a spacing of 120°; and four tables preferably at a spacing of 90°. Turned to its upper position, the pallet table 6 of FIG. 1 is horizontal so that the work piece W with the pallets P can be placed on it. The table 6 is then, in accordance with FIG. 1, placed at the change position. The table 6 is directly above the axle line X, but it can also be located on the side thereof, wherein all pallet tables are advantageously placed the same way. In that case the change position can be positioned on the other side of the washing station. The work piece W is fastened to the pallet P to prevent it from falling. The pallet P makes it possible to handle various work pieces W and to fasten them onto the axle 4. The pallet P further comprises means to which for example forks F of the stacker crane grab or on which they rest for moving and treatment.

The work piece W is supplied to the washing station 1 by means of a horizontal movement and a short vertical movement of the forks. The pallet table further comprises locking means (not shown in the figure) for fastening the pallet onto the table. The means are locking jaws, or the like, operated by electricity or a pressurized medium and situated on the upper surface of the table and adapting to the counterpart means on the lower surface of the pallet. The space required by the forks F is illustrated with a hatched area. The maximum space required by the pieces W is illustrated with a line of dots and dashes. The pallet tables move simultaneously along a circular path R, usually step by step.

With reference to FIG. 1 and in accordance with a preferred embodiment of the invention, the tables 6, 7 are provided with a rotary movement to rotate the work piece W with the pallets P around a substantially vertical direction Y, preferably in both directions. This can be implemented by means of an apparatus, such as a rotating motor 5, or the like. In combination with the rotary movement that the axle 4 performs around the direction X, remarkably versatile rotation positions and inclination positions are achieved for the piece W. The versatile positions can also be obtained by arranging the axle X inclined, preferably at an upward angle of 45°. In that case, the change position corresponds to the one shown in FIG. 1, but the work piece shows, at its lowest position, an inclination of 90°.

The washing station 1 further comprises a spray apparatus 8 for washing and rinsing. While the washing station 1 comprises both a rotary movement X and a rotary movement Y, the flush apparatus is only provided with fixed fluid jets and/or air jets. The spray apparatus 8 of FIG. 1 comprises a fork-like tubing 9 that is rotatable or rotated by the jets and has holes to create the jets. The apparatus 8 is connected to a water distribution system, a pressurized air system or a fluid container of its own, by means of pumps and valves, if necessary. The tubing 9 rotates, supported by an arm 10, around the work piece W, wherein the rotary movement Y is not necessary. The pallet table is thus turned to the low position, in the similar way as the pallet table 7 in FIG. 1. The table 7 is thus, and in accordance with FIG. 1, positioned at the treatment position. The arm 10 is fixed to the frame structure 2 of the washing station 1, which structure supports the other end of the axle 4 by means of a joint 11.

While the piece W of the table 7 is being washed, also the piece of the table 6 can be handled, for example detached for removal or fastened for washing. The treatment is performed with forks F. A casing that is open at its upper end is applied inside the frame, this casing being a launder-like splash apron 12 comprising two vertical walls that are transverse in relation to the X-axis and extend at least as high as the axle 4. At least one of the walls is provided with a cut hole 13 for the work piece W and the fork F. Two or more horizontal partition walls 14 are fastened to the axle 4 to operate as covers closing the apron 12 and protecting against splashes. By means of the partition walls 14 and the apron 12, each piece W can be separated to form a separate compartment of its own for different work phases, such as fluid jetting, air jetting, drying, drainage, changing, or emptying. The walls 14 have a sufficient space to rotate inside the apron 12, and their outer path is illustrated by a dotted line L. The position of the horizontal walls 14 inside the apron 12 is illustrated by a dotted line. Sealings applied on the edges of the partition walls 14 are used for preventing splashes. The walls are also used for directing the liquid and the chips to a determined place. The liquid and the chips are collected in a basin 15 of a collecting system 16, from which they can be collected manually or by machine.

The washing station can be applied in a piece processing system that is typically at least partially separated with a protective fence to prevent hoists and transfer apparatus from entering the work area. The stacker crane is provided with an apparatus, for example transfer forks, telescopic forks, hoisting mechanisms and the like, for treating a work piece by means of a pallet P. The crane is transferred between storage shelves, change positions and manufacturing machines. The system is controlled in a way known as such, automatically by means of a control program stored in a control system. The control system in question and/or the control system of the washing station itself attend to the operating sequence and the operation of the motor 5 and the flushing apparatus 8.

The operating sequence of the station 1 is for example as follows. The forks F are used for bringing a piece W1 to an opened upper table 6 and locked. Simultaneously, a piece W2 can be treated for example by an air jet. The axle 4 is turned 180° bringing up the piece W2 that was on the lower table 7. The locking of the table 7 is released and the piece W2 is lifted off by forks F. At the same time, the piece W1 is washed and rotated with a determined sequence. After the change, the axle 4 can be rotated to different positions in order to drain the piece W1. Subsequently, the table 7 is turned to its upper position to receive a new piece, and the sequence starts again. However, it is not always necessary to remove the second piece, but both pieces can be treated, or one of the pieces can be drained in the upper position during the washing.

Particularly in a washing station comprising three or more tables, it is possible to have the pieces at different stages. For example the first table can be at the change position to bring the piece, the second table at the first treatment position at the washing stage, and the third table at the second treatment position at the drainage stage, wherein a particularly effective sequence can be achieved. Further, the fourth table can be treated with air jetting or rinsing. After the phases are completed and a new piece has been brought in, the processed piece is transported up for removal. Also a piece located in the upper position and waiting can for example be dried by an air jet. The station can also be used so that the elevator or the transfer device is removed after the piece has been brought in, wherein every table can be used for treating a piece.

It is obvious that the stacker crane and the treatment system can vary to a great extent. The washing station can also be provided with one or more rotors or manipulators, for example for deburring. The other tables can be washed simultaneously, wherein the operation is particularly efficient. It is also possible to consider utilizing the same robots also in the washing.

The present invention is not limited solely to the above-presented and exemplified embodiments, but it can be modified within the scope of the appended claims.

1. A washing and rinsing station for treatment of work pieces fastened onto a pallet, which station comprises a pallet table arranged for receiving and delivering the pallet and for locking it at its place, wherein the pallet table is connected on a rotation axle for turning the work piece by inclining it off from a change position to a treatment position, characterized in that at least one pallet table is further connected to said rotation axle in a way that said pallet tables swivel around the rotation axle simultaneously and in the same direction on a circular path when one pallet table is turned from the change position to the treatment position, for washing, cleaning or drainage, wherein another pallet table is at the same manner arranged to turn from the treatment position to the change position for a pallet change.

2. The washing and rinsing station according to claim 1, characterized in that the rotation axle is preferably substantially horizontal or substantially at an upward angle of 45° in relation to a horizontal direction.

3. The washing and rinsing station according to claim 1 or 2, characterized in that to the rotation axle is connected at least one partition wall which turns with the pallet tables and which is arranged to separate work pieces from each other.

4. The washing and rinsing station according to claim 1 or 2, characterized in that the pallet tables with the work pieces are arranged to move within a launder-like casing, and that at least one partition wall is connected to the rotation axle to turn with the pallet tables and to close the work piece at the treatment position.

5. The washing and rinsing station according to claim 1, characterized in that a rotary movement is arranged on the pallet tables to rotate the work piece with the pallets.

6. The washing and rinsing station according to claim 1, characterized in that it is provided with a collecting system for collecting washing and rinsing fluids and chips falling from the work piece.

7. The washing and rinsing station according to claim 1 or 6, characterized in that at least one treatment position is provided with a spray apparatus for spraying washing or rinsing fluids and/or air.

8. The washing and rinsing station according to claim 1 or 2, characterized in that the pallet table is positioned on a rotation axle and higher than the treatment positions, when said pallet table is at the change position.

9. The washing and rinsing station according to claim 1 or 2, characterized in that the pallet tables are connected on the rotation axle at regular spaces.

10. A method in a washing and rinsing station for treatment of work pieces fastened onto a pallet, which station comprises a pallet table arranged for receiving and delivering the pallet and for locking it at its place, wherein the pallet table, connected on a rotation axle, is turned for turning a work piece by inclining it away from a change position to a treatment position, characterized in that also at least one pallet table connected to said rotation axle is turned around the rotation axle simultaneously and in the same direction on a circular route when the former pallet table is swivelled from the change position to the treatment position, for washing, cleaning or drainage, wherein said at least one pallet table is at the same time turned from the treatment position to the change position for a pallet change.
